(19) United States
(12) Patent Application Publication
(10) Pub. No.: US 2019/0337782 A1
(43) Pub. Date: Nov. 7, 2019

(54) HIGH CAPACITY TOOLBOX SUPPORT FOR USE WITH A PALLET JACK THAT DOES NOT INTERFERE WITH PALLET CARGO

(71) Applicant: Alexander P. Vashchenko, Woodburn, OR (US)

(72) Inventor: Alexander P. Vashchenko, Woodburn, OR (US)

(21) Appl. No.: 15/971,739

(22) Filed: May 4, 2018

(51) Int. Cl. B66F 9/075

(52) U.S. Cl. CPC B66F 9/07504; B25H 3/02

(57) ABSTRACT

A toolbox support for use with a pallet jack for carrying a toolbox. The toolbox support includes a U-shaped cradle configured to securely support the toolbox. The U-shaped cradle is supported by a vertical support member that includes a bottom end to be inserted into a slot at the base of the pallet jack frame, and a supporting horizontal foot is to be supported by an edge along the bottom of the slot in the pallet jack frame. The vertical support member is secured to the pallet jack by inserting a tab of an angle bracket attached to the pallet jack frame into an engagement slot attached along the vertical support member. The toolbox support does not interfere with cargo loaded on the pallet jack, and securely carries the toolbox on the pallet jack while the operator performs jobs, thereby increasing the productivity of the pallet jack operator.

### FIELD OF THE INVENTION

This invention relates generally to devices for carrying tools and materials, and more particularly to devices for carrying tools and materials on a pallet jack.

### BACKGROUND OF THE INVENTION

Pallet jacks are used to transfer cargo from one location to another in warehouses, factory floors, and outdoor lots such as lumber yards. Typically, pallet jacks are motorized vehicles that can move more quickly than a human worker can walk, and the pallet jack can carry more cargo than a human worker can carry.

Pallet jack operators often require tools or materials to perform their work. Common examples of work materials include: rolls of binding tape, cutting devices such as knives, scissors, and box cutters, marking tools such as felt-tip marking pens, and labels and stickers for labelling the cargo on a pallet jack. It is desirable for these and other tools and materials to be transported along with the pallet jack operator as the pallet jack moves across the warehouse, factory floor, or outdoor storage yard.

As an example, a pallet jack operator may need to transport a pallet full of soap boxes across a warehouse floor. When the operator reaches the drop-off destination and unloads the soap boxes from the pallet jack, the operator may be required to wrap the soap boxes with binding tape, and then cut the binding tape off from a roll of binding tape using a knife. During the course of a work day, the pallet jack operator may visit dozens of drop-off locations throughout the warehouse floor. Since typically there will not be rolls of binding tape and knives at every location throughout the warehouse, the pallet jack operator will save time if the rolls of binding tape and the knife are carried on the pallet jack.

However, a typical pallet jack does not include an area or a location on the pallet jack for carrying tools and other work materials. The lack of a location on the pallet jack for carrying tools and work materials can prevent the operator from performing their essential work duties in a timely manner. If the operator must drive the pallet jack back and forth across a warehouse just to fetch needed work materials, the operator's time can be wasted and his productivity can be greatly diminished.

Trine et. al, U.S. Pat. No. 7,810,821 B2 teaches a storage device for use with a pallet jack. However, the supporting frame assembly of this device protrudes into the space immediately above the pallet jack forks, and therefore the supporting frame assembly interferes with the cargo carrying area of the pallet jack, thereby reducing and restricting the amount of cargo that can be carried by the pallet jack.

### SUMMARY OF THE INVENTION

The toolbox support of the invention assists the operator of a pallet jack by conveniently carrying tools and other materials on the pallet jack along with the operator as he/she drives the pallet jack. In a preferred embodiment, the vertical support member of the toolbox support of the invention is only substantially 1/8″ in thickness, and therefore does not extend into the cargo area above the forks of the pallet jack, and therefore does not interfere with the cargo carrying capacity of the pallet jack. In addition, the toolbox support of the invention supports and elevates the toolbox above the height of the cargo, further ensuring that the toolbox does not interfere with the cargo carrying capacity of the pallet jack.

Also, because the toolbox support can accommodate a toolbox of a size that can carry several cubic feet of tools and materials can be used.

The toolbox support of the invention increases the speed and productivity of the pallet jack operator.

A general aspect of the invention is a toolbox support for use with a pallet jack and a toolbox, the toolbox having a handle recess on each side, and the pallet jack having a pallet jack frame with a pallet jack frame slot. The toolbox support includes: a U-shaped cradle configured to receive and securely support the toolbox, the U-shaped cradle including: a first arm, a second arm, and a bottom portion therebetween, the first arm and the second arm extending upward and configured to engage a recess on each side of the toolbox; a vertical support member including: a top end fixedly attached to the U-shaped cradle, a tab engagement slot fixedly attached at a position along the vertical support member, and a bottom end configured to be inserted into the pallet jack frame slot; and a supporting horizontal foot, fixedly attached to the vertical support member above the bottom end of the vertical support member, the supporting horizontal foot having a lower edge configured to rest on an edge of the pallet jack frame slot.

In some embodiments, the supporting horizontal foot is attached at a position along the vertical support member with respect to the tab engagement slot such that the full weight of the toolbox will be supported by the supporting horizontal foot when the supporting horizontal foot rests upon the front edge of the horizontal slot.

In some embodiments, the toolbox support further includes: an angle bracket including an angle bracket body having at least one bolt hole for receiving at least one bolt configured to fixedly attach the angle bracket body to the pallet jack frame, and a tab extending from the angle bracket body, the male tab configured to slide into and securely engage with the tab engagement slot.

In some embodiments, the U-shaped cradle, the vertical support member, and the supporting horizontal foot are made of at least one of: metal, sheet metal, and plastic.

In some embodiments, the vertical support member is made from a single piece of sheet metal.

In some embodiments, the U-shaped cradle is made of a single piece of sheet metal.

In some embodiments, the U-shaped cradle is made of a single piece of sheet metal that is bent in two places to form the first arm, the second arm, and the bottom portion of the U-shaped cradle.

In some embodiments, the U-shaped cradle is fixedly attached to the vertical support member by at least one weld.

In some embodiments, the supporting horizontal foot is made of a single piece of sheet metal.

In some embodiments, the supporting horizontal foot is fixedly attached to the vertical support member by at least one weld.

Another general aspect of the invention is a toolbox support for use with a pallet jack and a toolbox, the toolbox having a handle recess on each side, and the pallet jack having a pallet jack frame with a pallet jack frame slot. This toolbox support includes: a U-shaped cradle configured to receive and securely support the toolbox, the U-shaped cradle including: a first arm, a second arm, and a bottom portion therebetween, the first arm and the second arm extending upward and configured to engage a recess on each side of the toolbox; a vertical support member including: a top end fixedly attached to the U-shaped cradle, a tab engagement slot fixedly attached at a position along the vertical support member, and a bottom end configured to be inserted into the pallet jack frame slot; an angle bracket including: an angle bracket body having at least one bolt hole for receiving at least one bolt configured to fixedly attach the angle bracket body to the pallet jack frame, and a tab extending from the angle bracket body, the tab configured to slide into and securely engage with the tab engagement slot of the vertical support member; and a supporting horizontal foot, fixedly attached to the vertical support member above the bottom end of the vertical support member, the supporting horizontal foot having a lower edge configured to rest on an edge of the pallet jack frame slot.

In some embodiments, the supporting horizontal foot is attached at a position along the vertical support member with respect to the tab engagement slot such that the full weight of the toolbox will be supported by the supporting horizontal foot when the supporting horizontal foot rests upon the front edge of the horizontal slot.

In some embodiments, the U-shaped cradle, the vertical support member, and the supporting horizontal foot are made of at least one of: metal, sheet metal, and plastic.

In some embodiments, the vertical support member is made from a single piece of sheet metal.

In some embodiments, the U-shaped cradle is made of a single piece of sheet metal.

In some embodiments, the U-shaped cradle is fixedly attached to the vertical support member by at least one weld.

In some embodiments, the U-shaped cradle is made of a single piece of sheet metal that is bent in two places to form the first arm, the second arm, and the bottom portion of the U-shaped cradle.

In some embodiments, the supporting horizontal foot is made of a single piece of sheet metal.

In some embodiments, the supporting horizontal foot is fixedly attached to the vertical support member by at least one weld.

### BRIEF DESCRIPTION OF THE DRAWINGS

Many additional features and advantages will become apparent to those skilled in the art upon reading the following description, when considered in conjunction with the accompanying drawings, wherein:

FIG. 1 is an isometric view showing a pallet jack for use with the toolbox support of the invention.

FIG. 2 is an isometric front view of an embodiment of the toolbox support having a U-shaped cradle, a vertical support member, and a supporting horizontal foot.

FIG. 3 is an isometric rear view of the U-shaped cradle, the vertical support member, the supporting horizontal foot, and the tab engagement slot of the toolbox support of FIG. 2.

FIG. 4A is an isometric front view of an angle bracket having a tab.

FIG. 4B is an isometric rear view of the angle bracket and the tab of FIG. 4A.

FIG. 5A is an isometric view of the angle bracket of FIG. 4A mounted on the pallet jack frame, the vertical support member being removably secured to the angle bracket due to the tab being engaged in the tab engagement slot.

FIG. 5B is a cross-sectional side view of the angle bracket of FIG. 4A mounted on the pallet jack frame, showing the tab inserted into the tab engagement slot.

FIG. 6 is an isometric front view of the pallet jack with a toolbox support mounted on the pallet jack frame, and the vertical support member of the toolbox support removably secured to the angle bracket.

FIG. 7 is an isometric rear view of the pallet jack with the toolbox support mounted on the pallet jack.

FIG. 8 is a close-up isometric front view of the toolbox support mounted on the pallet jack, the toolbox support supporting a toolbox, both the first arm and the second arm engaged with a handle recess in a respective end of the toolbox.

FIG. 9 is an isometric front view of the pallet jack having the toolbox support mounted on the pallet jack frame, the toolbox support supporting a toolbox, the horizontal foot of the vertical support member resting on an edge of a horizontal slot of pallet jack frame, and the tab of the angle bracket securing the vertical support member to the pallet jack frame.

### DETAILED DESCRIPTION

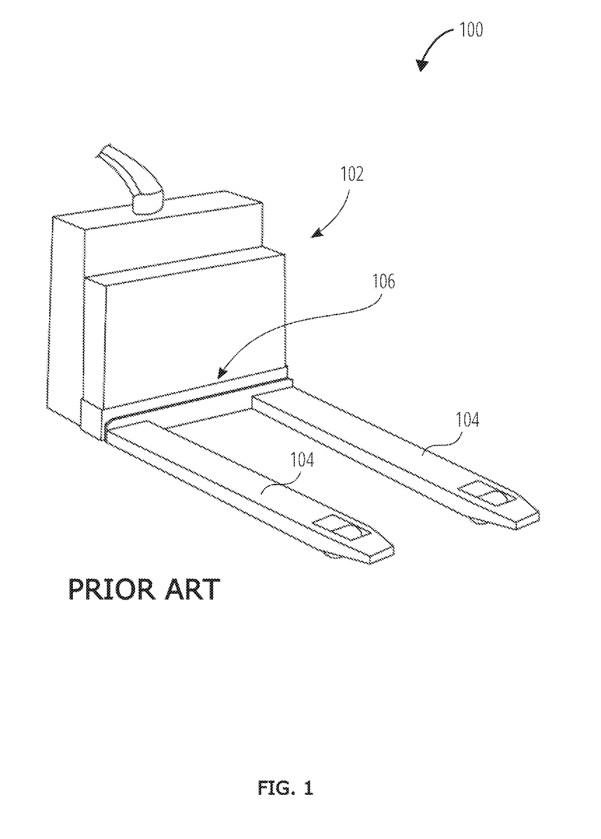

With reference to FIG. 1, a typical pallet jack 100 is shown. The pallet jack 100 includes a pallet jack frame 102, a pair of pallet jack forks 104, and a horizontal slot 106 of the pallet jack frame 102, situated between the pair of pallet jack forks 104.

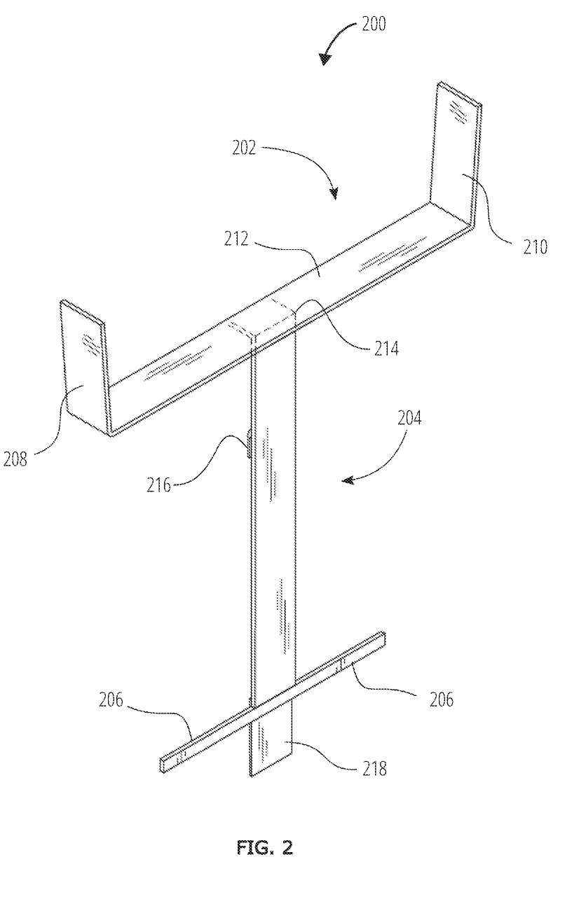

With reference to FIG. 2, an embodiment of the toolbox support 200 is shown, the toolbox support having a U-shaped cradle 202, a vertical support member 204, and a supporting horizontal foot 206.

The U-shaped cradle 202 includes a first arm 208, a second arm 210, and a bottom portion 212. The vertical support member 204 includes a top end 214, a tab engagement slot 216, and a bottom end 218.

In some embodiments, the U-shaped cradle 202, the vertical support member 204, and the supporting horizontal foot 206 are made of at least one of: metal, sheet metal, and plastic. In some embodiments, the vertical support member 204 is made from a single piece of sheet metal. In some embodiments, the U-shaped cradle 202 is formed from a single piece of sheet metal. In some embodiments, the U-shaped cradle 202 is made of a single piece of sheet metal that is bent in two places to form the first arm 208, the second arm 210, and the bottom portion 212 of the U-shaped cradle 202. In some embodiments, the U-shaped cradle 202 is fixedly attached to the vertical support member 204 by welding. In some embodiments, the supporting horizontal foot 206 is made of a single piece of sheet metal. In some embodiments, the supporting horizontal foot 206 is fixedly attached to the vertical support member 204 by welding.

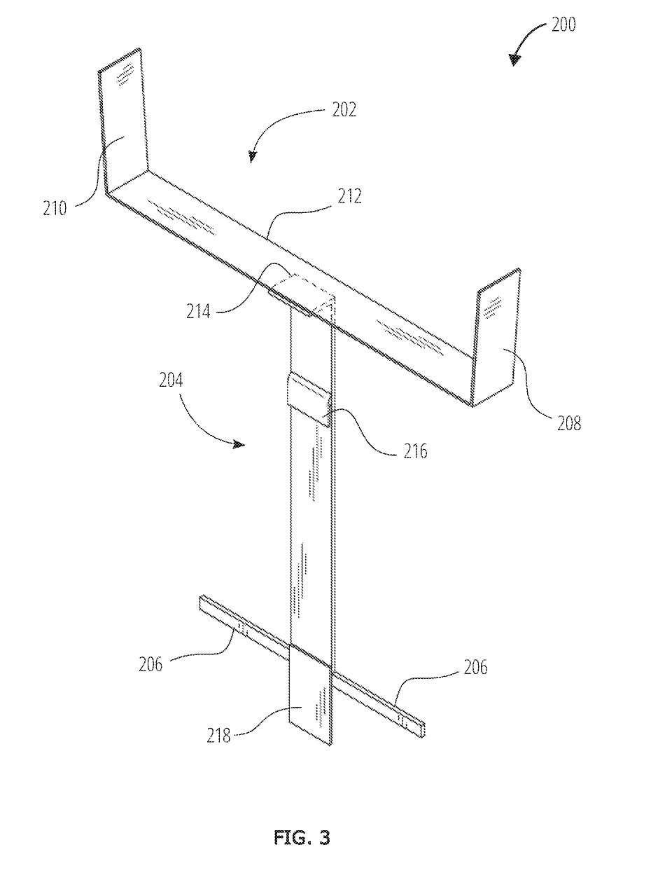

With reference to FIG. 3, a rear view of the toolbox support 200 is shown, again showing the U-shaped cradle 202, the vertical support member 204, and the supporting horizontal foot 206 of a toolbox support 200.

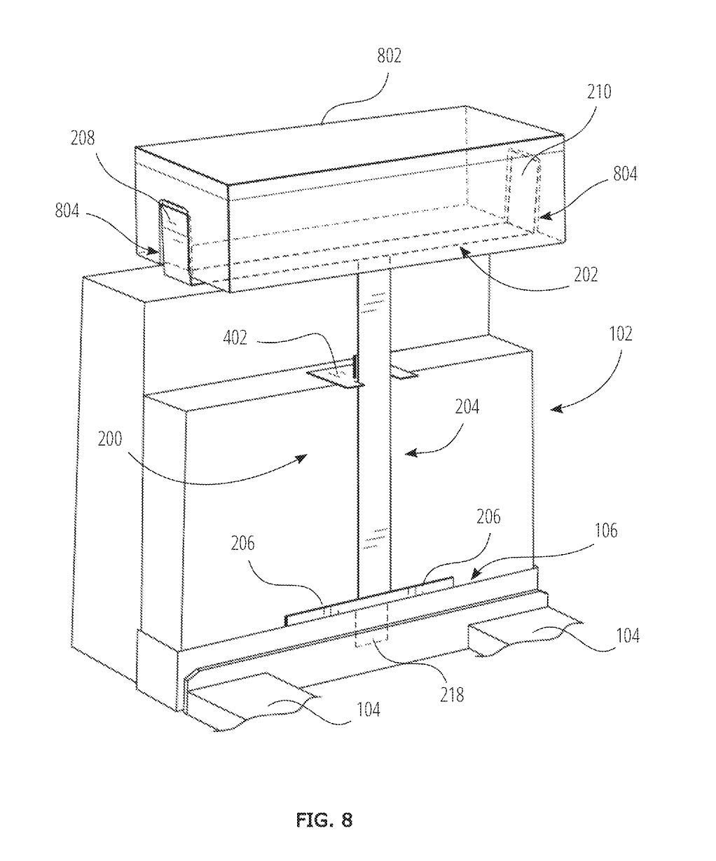

The first arm 208 and a second arm 210 of the U-shaped cradle 202 are shaped and sized so as to engage with the handle recesses (see FIG. 8) of a toolbox 802, thereby ensuring that the toolbox 802 does not fall backward or forward off of the U-shaped cradle 202 when the pallet jack 100 starts or stops.

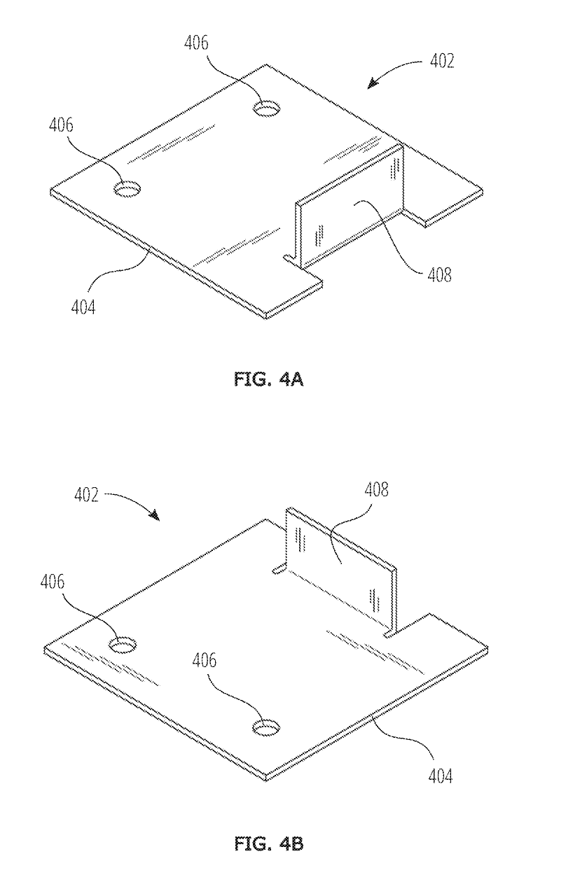

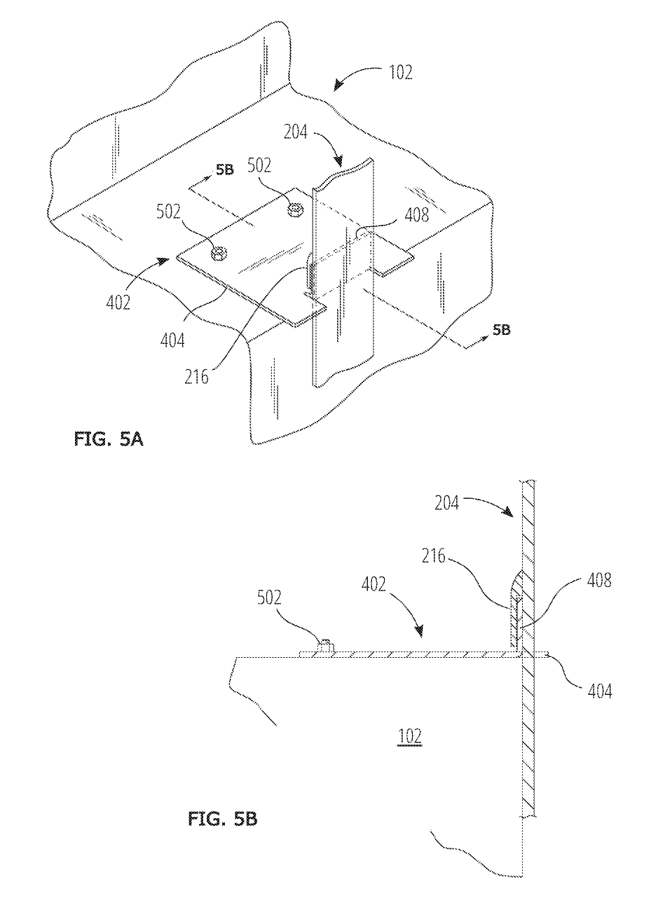

With reference to FIG. 4A, an angle bracket 402 is shown, including an angle bracket body 404, having at least one bolt hole 406, each of which receives a bolt (not shown) for attaching the angle bracket body 404 to the pallet jack frame 102 (shown in FIG. 5A). Also shown is a tab 408 which is configured to engage with a tab engagement slot 216 of the vertical support member 204 (shown in FIG. 2) so as to removably secure the vertical support member 204 to the pallet jack frame 102.

With reference to FIG. 4B, a rear view is shown of the angle bracket 402.

With reference to FIG. 5A, the angle bracket 402 is again shown, attached by an at least one bolt 502 to the pallet jack frame 102. The tab 408 (shown mostly by hidden lines) is shown extending upward from an angle bracket body 404, and engaging with the tab engagement slot 216 of the vertical support member 204 so as to removably secure the vertical support member 204 of the toolbox support 200 (shown in FIG. 2) to the pallet jack frame 102.

With reference to FIG. 5B, a cross-sectional side view is shown of the angle bracket 402, attached by an at least one bolt 502 to the pallet jack frame 102. A tab 408 extends upward from the angle bracket body 404, and engages with the tab engagement slot 216 so as to removably secure the vertical support member 204 of a toolbox support 200 (shown in FIG. 2) to the pallet jack frame 102. Thus, when the pallet jack 100 surges forward, the toolbox support 200 does not fall backwards away from the pallet jack frame 102.

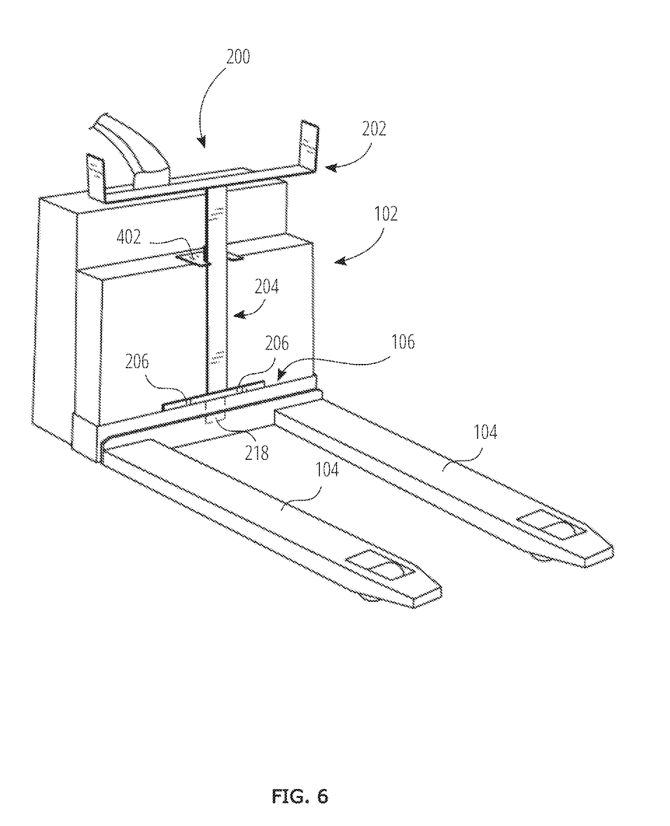

With reference to FIG. 6, a toolbox support 200 is shown mounted on a pallet jack 100. The vertical support member 204 of the toolbox support 200 is removably secured to the angle bracket 402 as shown in FIG. 5A, and a bottom end 218 (shown in hidden view) of the vertical support member 204 is removably inserted into a horizontal slot 106 in the pallet jack frame 102, situated between a pair of pallet jack forks 104. A supporting horizontal foot 206 rests upon a front edge of the horizontal slot 106.

When the supporting horizontal foot 206 rests upon the front edge of the horizontal slot 106, the tab engagement slot 216 is positioned relative to the tab 408 such that the tab 408 extends upward from the angle bracket body 404, and engages with the tab engagement slot 216 so as to leave a gap between the top of the tab 408 and the top of the inner surface of the tab engagement slot 216. Also, when the tab 408 engages with the tab engagement slot 216, the bottom of the outer surface of the tab engagement slot 216 does not reach the top surface of the angle bracket 402, thereby leaving a gap. Consequently, the full weight of the toolbox 802 and the toolbox support 200 is rests on the supporting horizontal foot 206 which rests upon the front edge of the horizontal slot 106.

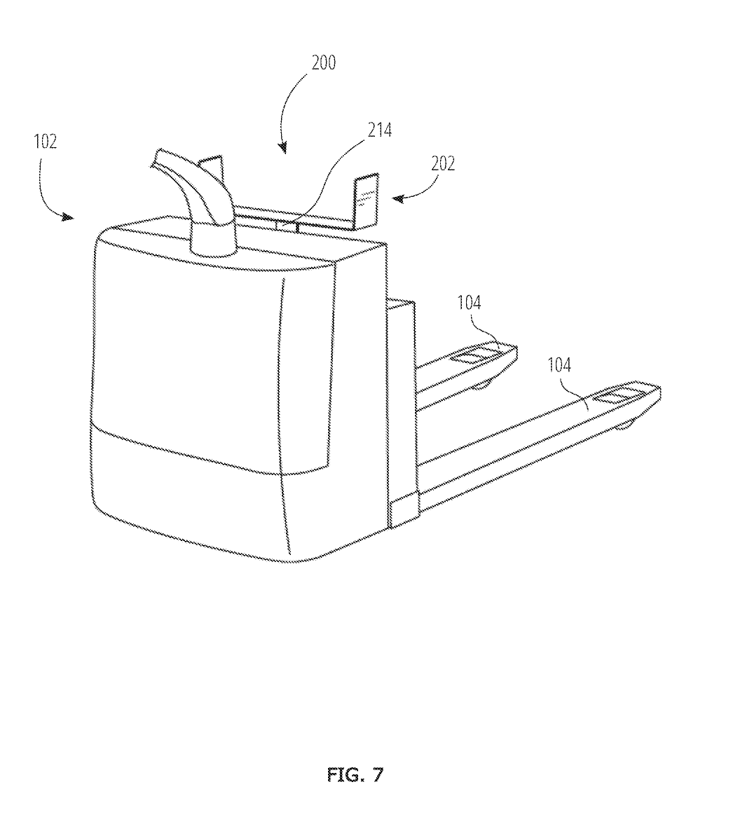

With reference to FIG. 7, a rear view is shown of the pallet jack 100 having a toolbox support 200 mounted thereon. The U-shaped cradle 202 and the top end 214 of the vertical support member 204 of the toolbox support 200 are visible extending just above the pallet jack frame 102. A pair of pallet jack forks 104 are also visible in this rear view.

With reference to FIG. 8, the toolbox support 200 is shown mounted on a pallet jack 100, and supporting a toolbox 802. The vertical support member 204 of the toolbox support 200 is removably attached to an angle bracket 402. The bottom end 218 (shown in hidden view) of the vertical support member 204 is inserted into the horizontal slot 106 of the pallet jack frame 102, situated between the pair of pallet jack forks 104. The supporting horizontal foot 206 rests on the front edge of the slot 106 of the pallet jack frame 102, between the pair of pallet jack forks 104.

Shown at each end of the toolbox 802 is a handle recess 804 that can be used to lift the toolbox 802 with two hands. According to the invention, both the first arm 208 and the second arm 210 of the U-shaped cradle 202 engage with the handle recess 804 in each end of the toolbox 802 so as to stabilize the toolbox 802 against sudden movement forward or backward by the pallet jack 100.

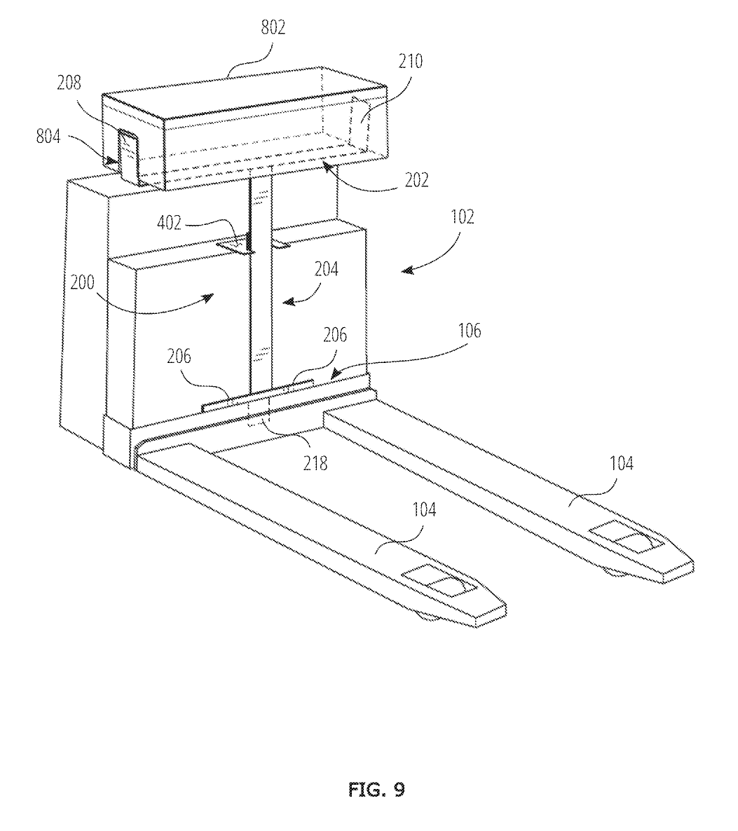

With reference to FIG. 9, a front view is shown of the toolbox support 200 mounted on a pallet jack 100, and supporting a toolbox 802. The toolbox support 200 is mounted on the pallet jack frame 102. A vertical support member 204 of the toolbox support 200 is removably secured to an angle bracket 402 by engagement of the tab 408 of the angle bracket 402 with the tab engagement slot 216 of the vertical support member 204. A bottom end 218 (shown in hidden view) of the vertical support member 204 is inserted into a horizontal slot 106 of the pallet jack frame 102, and between a pair of pallet jack forks 104. A supporting horizontal foot 206 of the vertical support member 204 is supported by a front edge of the slot 106 of the pallet jack frame 102, and is situated between the pair of pallet jack forks 104.

Shown at each end of the toolbox 802 is a handle recess 804 that facilitates grasping of the toolbox 802 at each end. The first arm 208 and the second arm 210 of the U-shaped cradle 202 are configured to engage with a respective handle recess 804 formed in each end of the toolbox 802.

Other modifications and implementations will occur to those skilled in the art without departing from the spirit and the scope of the invention as claimed. Accordingly, the above description is not intended to limit the invention, except as indicated in the following claims.

What is claimed is:

1. A toolbox support for use with a pallet jack and a toolbox, the toolbox having a handle recess on each side, and the pallet jack having a pallet jack frame with a pallet jack frame slot, the toolbox support comprising:
a U-shaped cradle configured to receive and securely support the toolbox, the U-shaped cradle including: a first arm, a second arm, and a bottom portion therebetween, the first arm and the second arm extending upward and configured to engage a recess on each side of the toolbox;
a vertical support member including: a top end fixedly attached to the U-shaped cradle, a tab engagement slot fixedly attached at a position along the vertical support member, and a bottom end configured to be inserted into the pallet jack frame slot; and
a supporting horizontal foot, fixedly attached to the vertical support member above the bottom end of the vertical support member, the supporting horizontal foot having a lower edge configured to rest on an edge of the pallet jack frame slot.

2. The toolbox support of claim 1, wherein the supporting horizontal foot is attached at a position along the vertical support member with respect to the tab engagement slot such that the full weight of the toolbox will be supported by the supporting horizontal foot when the supporting horizontal foot rests upon the front edge of the horizontal slot.

3. The toolbox support of claim 1, further comprising:
an angle bracket including: an angle bracket body having at least one bolt hole for receiving at least one bolt configured to fixedly attach the angle bracket body to the pallet jack frame, and a tab extending from the angle bracket body, the male tab configured to slide into and securely engage with the tab engagement slot.

4. The toolbox support of claim 1, wherein the U-shaped cradle, the vertical support member, and the supporting horizontal foot are made of at least one of: metal, sheet metal, and plastic.

5. The toolbox support of claim 1, wherein the vertical support member is made from a single piece of sheet metal.

6. The toolbox support of claim 1, wherein the U-shaped cradle is made of a single piece of sheet metal.

7. The toolbox support of claim 1, wherein the U-shaped cradle is made of a single piece of sheet metal that is bent in two places to form the first arm, the second arm, and the bottom portion of the U-shaped cradle.

8. The toolbox support of claim 1, wherein the U-shaped cradle is fixedly attached to the vertical support member by at least one weld.

9. The toolbox support of claim 1, wherein the supporting horizontal foot is made of a single piece of sheet metal.

10. The toolbox support of claim 1, wherein the supporting horizontal foot is fixedly attached to the vertical support member by at least one weld.

11. A toolbox support for use with a pallet jack and a toolbox, the toolbox having a handle recess on each side, and the pallet jack having a pallet jack frame with a pallet jack frame slot, the toolbox support comprising:
a U-shaped cradle configured to receive and securely support the toolbox, the U-shaped cradle including:
a first arm, a second arm, and a bottom portion therebetween, the first arm and the second arm extending upward and configured to engage a recess on each side of the toolbox;
a vertical support member including:
a top end fixedly attached to the U-shaped cradle, a tab engagement slot fixedly attached at a position along the vertical support member, and a bottom end configured to be inserted into the pallet jack frame slot;
an angle bracket including:
an angle bracket body having at least one bolt hole for receiving at least one bolt configured to fixedly attach the angle bracket body to the pallet jack frame, and a tab extending from the angle bracket body, the tab configured to slide into and securely engage with the tab engagement slot of the vertical support member; and
a supporting horizontal foot, fixedly attached to the vertical support member above the bottom end of the vertical support member, the supporting horizontal foot having a lower edge configured to rest on an edge of the pallet jack frame slot.

12. The toolbox support of claim 11, wherein the supporting horizontal foot is attached at a position along the vertical support member with respect to the tab engagement slot such that the full weight of the toolbox will be supported by the supporting horizontal foot when the supporting horizontal foot rests upon the front edge of the horizontal slot.

13. The toolbox support of claim 11, wherein the U-shaped cradle, the vertical support member, and the supporting horizontal foot are made of at least one of: metal, sheet metal, and plastic.

14. The toolbox support of claim 11, wherein the vertical support member is made from a single piece of sheet metal.

15. The toolbox support of claim 11, wherein the U-shaped cradle is made of a single piece of sheet metal.

16. The toolbox support of claim 11, wherein the U-shaped cradle is fixedly attached to the vertical support member by at least one weld.

17. The toolbox support of claim 11, wherein the U-shaped cradle is made of a single piece of sheet metal that is bent in two places to form the first arm, the second arm, and the bottom portion of the U-shaped cradle.

18. The toolbox support of claim 11, wherein the supporting horizontal foot is made of a single piece of sheet metal.

19. The toolbox support of claim 11, wherein the supporting horizontal foot is fixedly attached to the vertical support member by at least one weld.
